(19) United States
(12) Patent Application Publication
(10) Pub. No.: US 2009/0227202 A1
(43) Pub. Date: Sep. 10, 2009

(54) Relay

(75) Inventors: Klaus Doppler, Espoo (FI); Taneli Riihonen, Espoo (FI); Ari Hottinen, Espoo (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Corporation, Espoo (FI)

(21) Appl. No.: 12/086,592

(22) PCT Filed: Dec. 16, 2005
(86) PCT No.: PCT/IB2005/004096

§ 371 Date: Jul. 11, 2008

(51) Int. Cl. H04B 7/15

(52) U.S. Cl. 455/11.1

(57) ABSTRACT

A relay for use in a communications network, said relay comprising a receiver for receiving signals from a plurality of first nodes; a transmitter for transmitting a transmission signal derived from said received signal to at least one of a plurality of second nodes, said transmitter having a coverage area; control means for controlling the transmitter, whereby said transmission signal is transmitted by said transmitter to at least one of said second nodes over only a part of said coverage area.

### FIELD OF THE INVENTION

The present invention relates to a relay, a method of forwarding signal and a communication system.

### BACKGROUND OF THE INVENTION

Networks using relay units for forwarding of information are well known. In wireless networks such as cellular wireless networks, it is known to provide relay units for signals transmitted from base transceiver stations. In such arrangements the radio signal transmitted by a base transceiver station is received by a relay unit and is retransmitted by the relay unit, typically to a mobile terminal or other user equipment.

Currently, there is a challenge to ensure that there is sufficient coverage in a wireless network in order to provide high data rate services. With the current systems, usually only mobile terminals close to base stations have potentially a very high data rate. With the currently proposals, in order to achieve high data rate coverage, a greater number of base stations are required. However, increasing the number of base stations is costly.

Relay units or relays have been proposed in order to distribute the data rate more evenly in the cell. However, there are problems associated with integrating relays or relay units into a wireless communication system.

Particularly, in dense urban areas, multiple access interference is the primary limitation to network capacity. The known relay units that just amplify or receive signals, do little to improve the signal to interference ratio, since they transmit signals also to the neighbouring network nodes.

Carrier-Sense Multiple Access (CSMA) is one solution to reduce interference but it suffers from two problems. The first problem is the so-called hidden node problem. In this scenario, two transmitting nodes, S1 and S2 each communicate with different receiving nodes D1 and D2. Thus, transmitting node S1 communicates with receiving node D1 and transmitting node S2 communicates with node D2. Even though S1 and S2 cannot sense each others carrier, the transmitting node S2 causes interference at the first receiving node D1 and the first transmitting node S1 causes interference at the second receiving node D2.

The other problem is the so-called exposed node problem. In this problem, a source node hears another source node carrier and decides not to transmit. However, the transmission in practice would not have caused interference at the other receiver node and the channel access could have been granted. This results in the channel resource being used inefficiently.

US 2005/0059342 discloses a communications system which has relays. Each relay is associated with a particular base station.

US 2005/0025099 discloses a communications system with a relay which is associated with a master BTS.

US 2003/0214919 discloses relays in the context of a spread spectrum system where the relay is associated with a base station.

V. I. Morgenshtern et al, “Orthogonalisation in large interference networks, Proc. IEEE Int. Symposium on Information Theory, Adelaide Australia September 2005 is a paper dealing with fading interference relay networks where M single antenna source-destination terminal pairs communicate through a set of relays.

S-L. Wu et al, “Intelligent Medium Access for Mobile Ad Hoc Networks with Busy Tones and Power Control”, IEEE Journal on Selected Areas in Communications, Vol 18, No 9, September 2000 discloses a mobile ad hoc network which looks at using power control and busy tones to address the hidden terminal, exposed terminal problems.

Tobagi et al, “Packet Switching in Radio Channels: Part II—The Hidden Terminal Problem in Carrier Sense Multiple Access and the Busy Tone Solution”, IEEE Transactions on Communications, Vol. 23, Issue 12, December 1975, pages 1417-1433, describes the busy tone solution in a CSMA environment.

US 2004/0100929 describes a system where a relay determines a collision free transmission schedule based on the distance to an access point along a routing tree.

Hassibi et al, “On the Power Efficiency of Sensory and Ad-hoc wireless networks”, ISIT 2003, Yokihama Japan, considers the power efficiency of a communications channel.

Viswanath et al, “Opportunistic Beamforming using Dumb antennas”, IEEE transactions on Information Theory, vol. 48, No 6, June 2002 does not discuss relays.

Hammerstroem et al, “Space-Time Processing for Cooperative Relay Networks” describes a relay with one omnidirectional antenna whilst “Channel Adaptive Scheduling for Cooperative Relay Networks” and “Impact of Relay Gain Allocation on the Performance of Cooperative Diversity Networks” discusses channel scheduling and gain in relays.

In U.S. Pat. No. 6,795,685, a method and apparatus for repeated priority resolution in a wireless communication system describes CSMA for relay units but suffers from the hidden and exposed node problems.

US 2005/01537919, token-based receiver diversity, describes a relay unit transmit control by granting tokens based on the received signal strength.

US 2004/0100929, system and method for collision free transmission scheduling in a network, describes a system where a repeater determines collision free transmission schedule based on the distance to an access point along a routing tree.

U.S. Pat. No. 6,282,425 describes a cellular system with an antenna arranged in the border region between two cells.

R. Pabst et al describes “Relay-based Deployment Concepts for Wireless and Mobile Broadband Radio”, IEEE Communications Magazine, September 2005.

### SUMMARY OF THE INVENTION

It is an aim of embodiment of the present invention to address this difficulty.

According to a first aspect of the invention, there is provided a relay for use in a communications network, said relay comprising:
a receiver for receiving signals from a plurality of first nodes;
a transmitter for transmitting a transmission signal derived from said received signal to at least one of a plurality of second nodes, said transmitter having a coverage area;
control means for controlling the transmitter, whereby said transmission signal is transmitted by said transmitter to at least one of said second nodes over only a part of said coverage area.

According to a second aspect of the invention, there is provided a relay comprising:
a receiver for receiving a signal from a first node;
a transmitter for forwarding said signal to a second node;
wherein at least one of said receiver and transmitter is arranged to be spatially selective such that at least one of said receiver and transmitter spatially selects only part of a coverage area of said relay.

According to a third aspect of the invention, there is provided a relay method for use in a communications network, said comprising the steps of:
receiving signals from a plurality of first nodes;
transmitting a transmission signal derived from said received signal to one of a plurality of second nodes by controlling a transmitter to transmit the transmission signal over only a part of said coverage area.

In embodiments of the present invention, a relay unit is described which forwards the received signals selectively in space. To do this, a relay that is arranged to be at least partially aware of the surrounding environment and of the desirable and undesirable transmit and receive direction. Embodiments of the present invention seek to minimise the complexity of the relay or relay network.

### BRIEF DESCRIPTION OF DRAWINGS

For a better understanding of the present invention and as to how the same may be carried out, reference will now be made by way of example only the accompanying figures in which:

FIG. 1 shows part of a communications network embodying the present invention;

FIG. 2 shows a relay unit embodying the present invention;

FIG. 3 shows signalling in a network embodying the present invention;

FIG. 4 shows a model for an interference relay network utilised by embodiments of the present invention; and

FIG. 5 shows schematically the steps carried out by the processing circuitry of FIG. 2.

### DETAILED DESCRIPTION OF PREFERRED EMBODIMENTS OF THE INVENTION

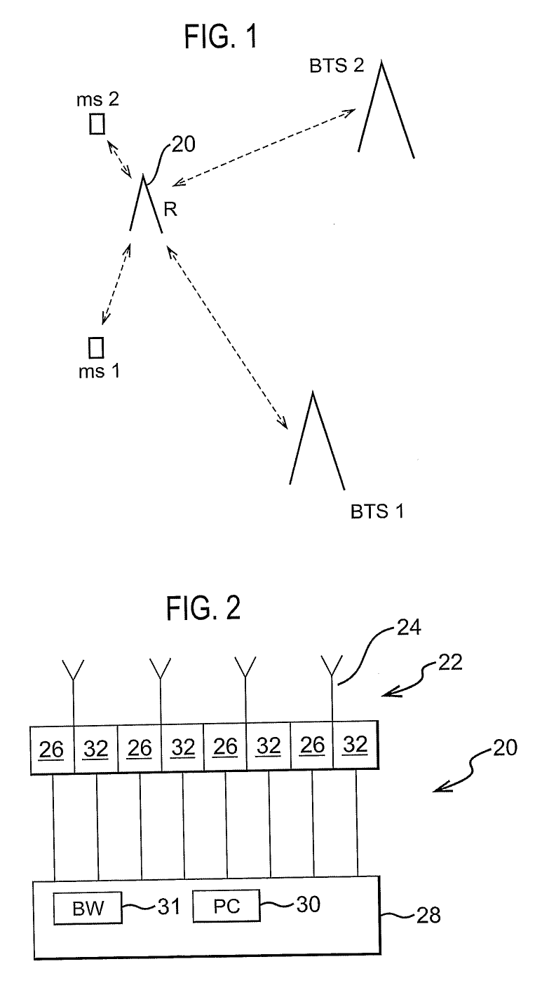

FIG. 1 shows an embodiment of the present invention. The communications network illustrated in FIG. 1 comprises a first base station BTS1 and a second base station BTS2. A relay unit R is provided. The relay unit R is arranged to be capable of communicating with the first base transceiver station BTS1 and the second base transceiver BTS2. The relay unit R is also capable of connecting to a first mobile station MS1 or a second mobile station MS2.

The mobile station can be any suitable form of user equipment such as a mobile station, mobile telephone, personal organiser, PDA (personal digital assistant), computer, portable computer, notebook or the like.

In practice many more than two mobile stations are provided. In the embodiment described, one relay unit is able to communicate with two base stations. This may be at the same time on the same or on different channels or it may be at different times. It should also be appreciated that in some embodiments of the invention a relay unit may be able to communicate with more than two base stations.

The relay unit embodying the present invention is shown in more detail in FIG. 2. The relay unit R is arranged to be able to steer a beam to any base station. Accordingly, in the example shown in FIG. 1, the relay unit R will be able to adapt its transmission radiation pattern and reception antenna pattern to base station BTS1 and/or to BTS2, as well as to MS1 and/or MS2. In particular, the relay can transmit and/or receive from the respective base transceiver stations and mobile stations. In order to keep interference to other base transceivers as low as possible, the relay unit and the base transceiver station additionally power control their transmitted signals. In other words the power is controlled to be the minimum required to communicate successfully, that is with a given signal-to-interference-and-noise ratio.

The relay unit 20 comprises an antenna array 22 which enables the relay unit to adapt its transmission radiation pattern and reception antenna pattern.

The antenna array 22 comprises a plurality of antenna 24. The example shown in FIG. 2 has four antennas but in practice the number of antennas may be more or less than this. The relay uses beam forming techniques to control the transmission and reception resources in a collaborative relay network. As will be described in more detail, beam forming is used to direct the signal energy to a desired direction. In this way, the transmit power can be minimised and at the same time also the interference to other directions is reduced.

The antenna 24 of the antenna array 22 are arranged both to receive signals and to transmit signals.

The antenna 24 are each connected to a receive circuit 26 which processes the receive signal. The receive circuit 26 may carry out one or more of the following: amplify the received signal, down convert the received signal, filter the received signal to remove unwanted information, and convert the signal to the digital domain.

The output of each of the receive circuits 26 is input to a processing circuit 28 which processes the output of the receive circuits to determine the signal to be transmitted.

The processing circuit 28 has information which determines the direction in which the signal is to be forwarded. The processing circuit also has a power control part 30 which determines the power with which the signal is to be transmitted. This may be on the basis of information which the relay has received from a node or may be on the basis of measurements made by the relay of the strength of received signals from the node in question or even a combination of these techniques.

Based on the information on the power required and the direction required, signals are output by the processing circuit to a transmit circuit 32, each of which is associated with an antenna. The transmit circuit may carry out one or more of the following: up convert the signal to the desired frequency, convert the signal information from the digital domain to the analogue domain, and amplify the signal using the power control information. The signals output by the processing circuit may have weights applied to them in order that when generated the beam will be steered in certain directions. A beam weight determining part 31 is illustrated as being part of the processing circuit 28. The beam weights applied to each of the signals transmitted by each antenna result in destructive and constructive signals depending on the directions to which the beams are steered. In other words the signal can be transmitted over only part of the coverage area of the antenna array in the directions defined by one or more beams.

It should be appreciated that in some embodiments of the invention, the relay may not down convert the received signal or convert the signal to the digital signal but instead simply retain the received signal at the received frequency and retransmit that signal in the desired direction.

Thus, the same relay unit is able to communicate with different base stations or mobile stations depending on the resource in the system.

It should be appreciated that the example of the relay shown in FIG. 2 illustrates the functionality. It should be appreciated that aspects of the transmit and/or receive circuitry may be incorporated in the processing circuit and vice versa.

It should be appreciated that preferred embodiments of the invention use an antenna array. It should be appreciated that embodiments of the present invention may be used with spatially selective radiation patterns that can be separately controlled.

In one embodiment of the present invention, the relay unit comprise calibrated arrays. In this embodiment, the relays and the base transceiver stations are assumed to be stationary. Therefore, calibration and the update of the array weights do not need to happen very often. Calibration can be done using any known method.

For example, if the GPS location of both the relay and the base transceiver station are known, this knowledge can be used to calibrate the relays and expensive hardware calibration can be avoided. The calibration and the update of the antenna array weights can happen at the time when the system network is low. If the GPS coordinates are not available, a trial and error method may be used. The relay transmits using predefined antenna array weights. Each base transceiver station signals back, when the weights maximize their received signal to noise ratio. Starting from these weights, the relay can then fine tune the weights to get to the final weight for each transceiver station. Again, feedback from the base transceiver station is required. This fine tuning algorithm can be used to update the weights, for example when the base transceiver station notices a worsening of the link quality to the relay unit.

In alternative embodiments of the present invention, an unstructured array can be used. Spatially separated antennas are used at the relay. If the BTS uses only one antenna to communicate with the relay, co-phasing of the signal transmitted by the relay can be used to maximize the received signal at the BTS. Here the relay unit transmits a pilot signal from each antenna and each base transceiver station estimates the relative phase shift between the pilot signals and signals information related to the phase shift to the relay for different antennas, preferably so that the signals are coherent at the selected base transceiver station. Alternatively each base transceiver station can signal the co-phase in weight to the relay and the relay stores them. Again the training can happen at the time when the network load is low or continuously. Co-phasing can also be used the other way round if the BTSs are equipped with multiple antennas and the relay has just one antenna. The relay node may also use other information to determine the antenna weights. For example, the relay may try to maximise the received signal power at a desired receiver while minimising the signal power at another receiver.

In alternative embodiments the relay unit comprises a set of directional antennas to communicate with the different base stations and mobile stations. The relay unit selects the best directional antenna to communicate with the base transceiver stations and the mobile stations.

Power control can be used at relay and at the base transceiver to keep the created interference as low as possible. In other words, the strength of the signals transmitted by the relay and the base transceiver station is minimised.

In embodiments of the present invention, this technique can also be used for the communication between the mobile station and the relay. In other words, beam forming can also be used.

In a wireless communication system, the relay may adapt its antenna weights to generate fixed beams for selected mobile stations in its coverage area. In some embodiments of the present invention, scheduling may also be used. The base transceiver station signals the relay unit, which beam to apply when forwarding the signal. Based on the feedback from a mobile station, the base transceiver knows which fixed beam maximizes the signal quality at the mobile station. When the base transceiver transmits a next time to the same mobile station it signals the relay to use this beam. The resulting signal quality can be used at the scheduler. In one embodiment of the present invention, the BTS may only schedule one user in the coverage area of each relay.

If the relay unit decodes and forwards the received signal, it only forwards a signal intended to a mobile station in its coverage area. The relay unit knows from the feedback of the mobile station the optimal beam and applies these beam forming weights when forwarding the signal to the mobile station. In the case of a CDMA system, only the code or the codes assigned to the intended mobile station in the coverage area of the relay are forwarded together with the necessary common channels.

Embodiments of the present invention can also be applied to OFDM and other multiplexing techniques. In the OFDM case, the method is generally the same and the following choices are for example possible: the same beam for all sub-carriers; each block of sub-carriers can have a separate beam; each sub-carrier gets a separate beam.

In the case of OFDMA, the relay only forwards sub-carriers assigned to mobile stations in the coverage-area of the relay.

In embodiments of the present invention, beam forming is used- to both of the relay and the base transceiver station and this can significantly reduce the interference created by the relay to other base transceiver stations or by the base transceiver station to other relays. Particularly in dense urban areas, the multiple access interference is the primary limitation to network capacity. Conventional relay units that just amplify and forward all received signals do little to improve the signal to interference power ratio. Accordingly, embodiments of the present invention use an intelligent relay that repeats the received signal selectively. In this case, the relay amplifies and forwards the signal selectively in a particular direction which only covers part of the area of coverage of the relay.

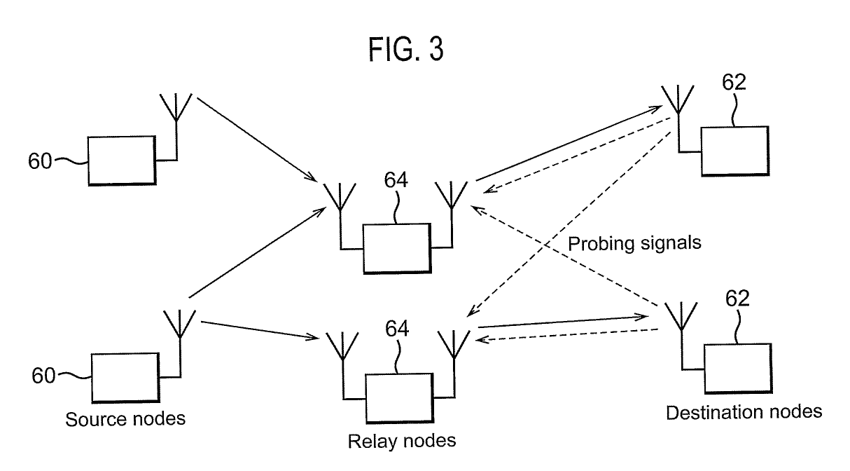

Reference is now made to FIG. 3 which shows in more detail a network embodying the present invention. The relay network comprises at least two source nodes and at least two destination nodes. The source nodes are marked 60 and the destination nodes are marked 62. The source nodes can be base transceiver stations and/or mobile stations whilst the destination nodes can be base stations and/or mobile stations. The source nodes 60 and the destination nodes 62 are arranged to communicate through at least one relay node 64. In the arrangement shown in FIG. 3 are two relay nodes. In embodiments of the present invention, no direct connection between the sources and the destinations is required but in some embodiments of the present invention there may be direct connections between the source and destination. It is also assumed that destinations know that they should be receiving a signal. This is achieved by using appropriate signalling.

Embodiments of the present invention use OFDM or CDMA channels. One OFDM or CDMA channel is divided into multiple sub-channels. One or more of these sub-channels are assigned for each source destination pair.

In embodiments of the present invention, the relay unit can relay different sub-channels for different source destination pairs. The relay unit can relay the whole received signal or only some selected sub-channels.

Embodiments of the present invention use a probe signalling protocol which is described in more detail hereinafter. Each destination node broadcasts a distinct probing signal that contains either a pilot signal or a feasibility data signal or both. The feasibility data contains one or more of the following information: Probing signal transmit power; resource allocation information; priority for relay and channel characteristics.

The relay node measures the channels frequency responses and decodes the possible feasibility information from every probing signal it receives. There may be signalling between the relay node about the usefulness of different frequency areas but this can be omitted in some embodiments. In this way, it is possible for the relays to make joint decisions on the resource allocation.

The intelligent relay may make its decision on relaying using information provided by the probing signal and other relays, that is transmit power controlling a resource allocation. The relay would not transmit on channels which are marked unusable by the probing signal or are marked as busy or congested.

In embodiments, of the present invention, resource allocation is performed between separate sub-channels. This is distinguished from prior art solutions based on BTMA where the transmit decision for every channel depends only on the presence of the channel busy tone. In embodiments of the present invention, the channels are also measured differently, because the present invention does not require different physical busy tone for every channel or channel chunk.

Resource allocation can be improved by using beam forming, power control, data rate control and/or any other known technique to improve radio link performance.

Embodiments of the present invention can be used for ad-hoc networks. A relay using BTMA of the prior art needs to listen to every channels busy tone. Using embodiments of the present invention, the relay needs only to listen to the jointly combined probing signal. Embodiments of the present invention can also be used for simple amplify and forward relays. The relay would need to only decode the possible feasibility information from the probing signal.

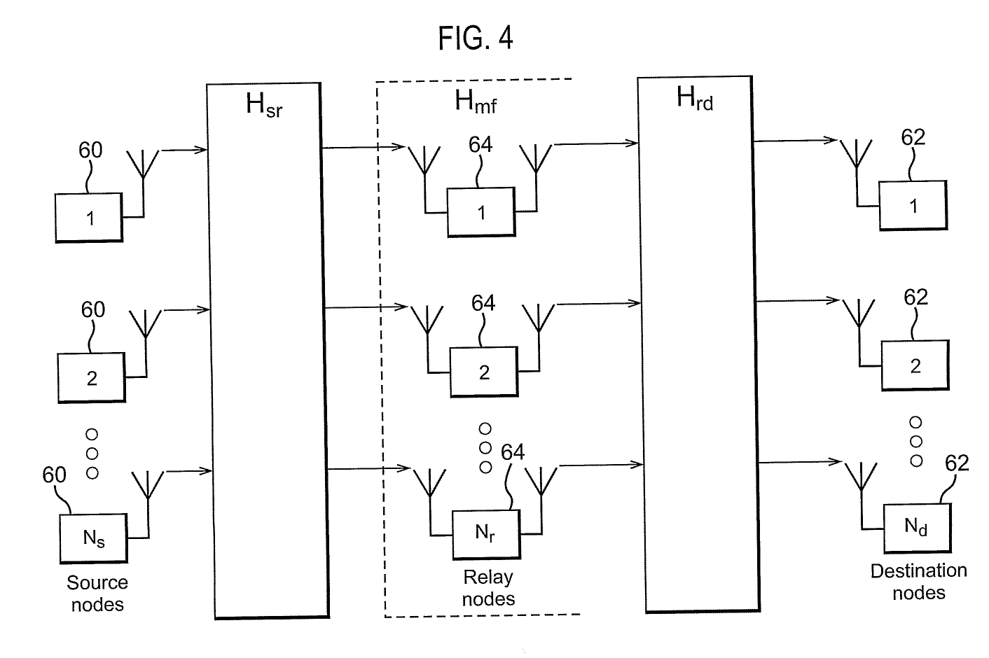

The protocol used in embodiments of the present invention will now be described with reference to FIG. 4 which shows the model for interference relay networks. The same numbering as used in relation to FIG. 3 is used in FIG. 4.

In this description, Ns×Nr×Nd is used for denoting a network with Nₛ source stations, Nᵣ relay stations and N_{d} destination stations. The destination nodes form together with the source nodes communicating source-destination pairs known by the relay unit. In the following, time division is assumed which guarantees separation between the signal transmitted by the sources and the signals transmitted by the relay units. A similar model can be used for frequency division. First, all sources transmit simultaneously and the relays receive the combined signals from all sources. Second, the relays can concurrently amplify and forward the signal to the destination. The system model can be written in matrix form:

$$\begin{matrix}y = {H}_{rd} {H}_{mf} {H}_{sr} x + {H}_{rd} {H}_{mf} {n}_{r} + {n}_{d} & ( 1 ) \\ = {H}_{eff} x + {n}_{eff} , & ( 2 )\end{matrix}$$

Where nᵣ is Nᵣ×1 relay receive noise vector and n_{d} is N_{d}×1 destination receive noise vector.

The MIMO channels between the stations can be divided into long-term and short-term parts i.e.

{Hₛᵣ}_{k,l}=\sqrt{E_{k,l}}h_{k,l}{H_{rd}}_{l,k}=\sqrt{P_{l,k}}·f_{l,k} (3)

The E_{k,l} and P_{l,k} denote the long-term average energy received through SISO-links (account for transmit power, path loss and shadowing). The h_{k,l} and f_{l,k} are the short-term flat fading coefficients.

The following summarises prior art on protocols that have been studied for interference relay networks in order to assist an understanding of the invention. Both protocols use a matched filtering operation to diagonalize the effective channel.

There are two different relaying modes for relays requiring different amount of CSI: In protocol 1 the relays are assumed to know only the phases of the backward and forward SISO-channels for the assisted communicating pair. In protocol 2 the relays know phases of backward and forward SISO-channels for every communicating pair. The relay operator H_{mf} in the MIMO-model is a diagonal matrix, which comes from the independent matched filtering operation in the relays. The matched filtering co-phases the relayed signal with respect to the backward and forward channels. This reduces interference by diagonalizing the effective channel matrix H_{eff} in a distributed manner. For the two protocols, the relay operation is the following:
Protocol 1: The set of relays is partitioned into Nₛ subsets and each subset is allocated for assisting one source-destination pair. The kth relay assists the communicating pair p(k). The kth relay receives signal rₖ and transmits signal

tₖ=τₖe^{-j(arg(h}^{_{k,p(k)}}^{)+arg(f}^{_{p(k),k}}⁾⁾rₖ, (4)

Where

$$τ = {( {\sum }_{l = 1}^{{N}_{s}} {E}_{k , l} + {σ}_{n}^{2} )}^{- 1 / 2}$$

is the power normalization factor ensuring ε[|tₖ|²]=1
Protocol 2: Each relay assists all communicating pairs and the relays are not divided into groups as in protocol 1. The kth relay receives signal rₖ and transmits signal

$${t}_{k} = {τ}_{k} ( {\sum }_{l = 1}^{{N}_{s}} {e}^{- j ( arg ( {h}_{l , k} ) + arg ( {f}_{l , k} ) )} ) {r}_{k} , \qquad ( 5 )$$

Where τₖ is a power normalization factor.

$${τ}_{k} = {( {N}_{s} {\sum }_{l = 1}^{{N}_{s}} {E}_{k , l} + {N}_{S} {σ}_{n}^{2} )}^{- 1 / 2}$$

In embodiments of the invention, the following protocol for the relay unit operation in interference relay networks is used:
Protocol 3: Each relay k can assist every communicating pair l and a weighting coefficient γ_{k,1} is introduced. The kth relay receives a signal rₖ and transmits the signal

$${t}_{k} = {τ}_{k} ( {\sum }_{l = 1}^{{N}_{s}} {γ}_{k , l} {e}^{- j ( arg ( {h}_{k , i} ) + arg ( {f}_{l , k} ) )} ) {r}_{k} , \qquad ( 6 )$$

Where τₖ is a power normalization factor.

Depending on the optimization criteria different strategies for choosing γ_{k,l} can be used. Examples for optimisation criteria are:
Minimise average bit error rate
Maximise signal-to-interference-and-noise ratio
Maximise network capacity
Minimise outage probability

Protocol 1 and protocol 2 mentioned in prior art are special cases of the proposed protocol 3. For protocol 1:

γ_{k,l}={_{0,otherwise}^{1,if.l=p(k)}
and for protocol 2: γ_{k,l}=1 for every relay k and communicating pair l.

One embodiment for choosing the γ_{k,l} is as follows:

A long term average of the weighting coefficients for each relay k to be used for each communicating pair l is defined by a relay allocation scheme. A simple allocation scheme would set for example γ_{k,l}=0 for communicating pairs l that should not be assisted by relay k.

The relay chooses the instantaneous γ_{k,l} based on the instantaneous channel gains for each communicating pair it assists, exploiting the temporal channel gain variations. For example the relay could try to maximise the average signal-to-noise ratio for the communicating pairs it assists. The relay is taking into account the following constraints:
Long term averages of γ_{k,l} are met
Transmitted power at each time instant is below a pre-defined threshold

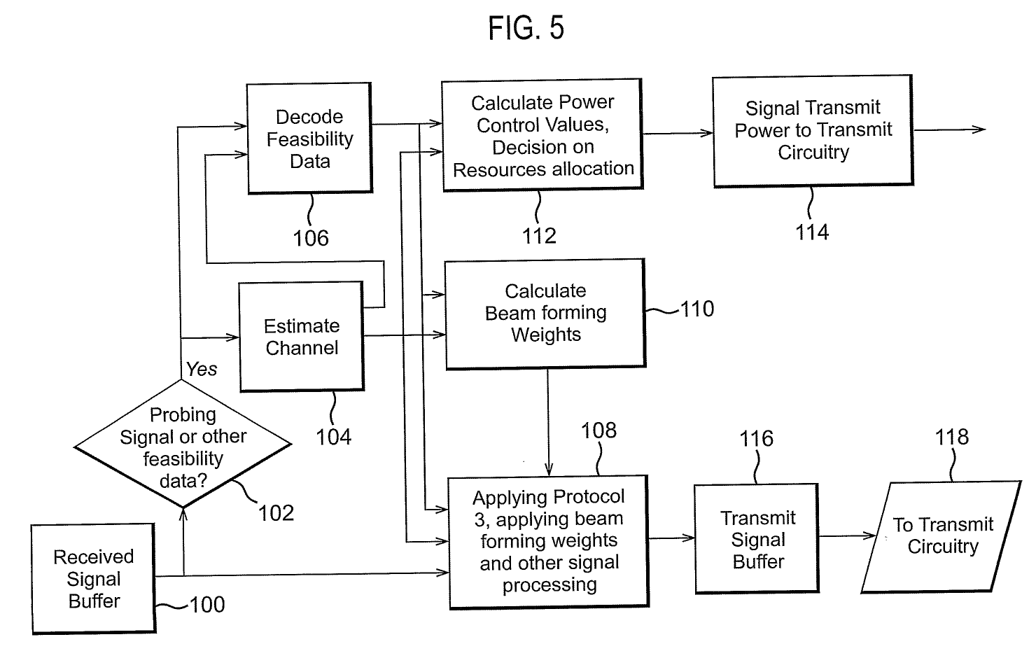

Reference is made to FIG. 5 which shows schematically the steps carried out by the processing circuitry of FIG. 2. Reference is made in the following to “blocks”. These are not physical blocks but rather represent different processing steps. The blocks may be implemented by a computer program.

A received signal is stored in a receive signal buffer 100.

The received signal is analysed to see if the received signal contains a probing signal or other feasibility data. This is done at block 102.

If there is feasibility data, this is decoded at block 106 and output to power control block 112, weight block 110 and protocol block 108.

If there is a probing signal or other feasibility data, the channel is estimated by block 104. The estimated channel information is output to power control block 112, weight block 110 and protocol block 108.

The power control block 112 calculates the power control values and makes decisions on resource allocation. As represented by block 114, the signal transmit power information is sent to the transmit circuitry.

The beam forming weights are calculated at block 110 and input to protocol block 108 which further receives the received signal. The protocol block 108 applies protocol 3, applies the beam forming weights and may carry out other signal processing. The output of protocol block 108 is stored in a transmit signal buffer 116 before being sent to the transmit circuitry as represented by block 118.

In the described embodiments, reference has been made to pilot signals or pilot tones. It should be appreciated that embodiments of the invention may be alternatively implemented using any other signal containing known data such as for example a training sequence or the like.

In embodiments of the present invention, reference has been made to resource allocation. Resource will depend on standard being used by the system and may be channels or sub-channels. For example, channels may be defined by one or more of time, frequency, code or the like.

In preferred embodiments of the invention, a common array is provided for receiving and transmitting.

In alternative embodiments of the present invention, there may be different arrays for receiving and transmitting.

It should be appreciated that at least the control of the relays may be implemented by a computer program.

1. A relay for use in a communications network, said relay comprising:
a receiver for receiving signals from a plurality of first nodes;
a transmitter for transmitting a transmission signal derived from said received signal to at least one of a plurality of second nodes, said transmitter having a coverage area;
control means for controlling the transmitter, whereby said transmission signal is transmitted by said transmitter to at least one of said second nodes over only a part of said coverage area.

2. A relay as claimed in claim 1, wherein said control means is arranged whereby a signal received by said receiver using a reception antenna pattern selective to a respective one or more of said first nodes is used to derive said transmission signal for said transmitter.

3. A relay as claimed in claim 1, wherein said transmitter is arranged to transmit said transmission signal using a transmission radiation pattern which is selective to one or more of said second nodes.

4. A relay as claimed in claim 1, wherein said relay is arranged to form at least two radiation patterns.

5. A relay as claimed in claim 1, wherein said control means is arranged to use at least one of:
channel information related to a channel between the relay and at least one of said first or second nodes; and/or information derived at first or second nodes.

6. A relay as claimed in claim 5, wherein said information derived at said second or first nodes comprises at least one of:
channel state information; channel quality information for a channel or a sub channel; and feasibility data signal information.

7. A relay as claimed in claim 5, wherein said receiver is arranged to receive said information.

8. A relay as claimed in claim 5, wherein said control means is arranged to control at least one or more of the following:
antenna radiation pattern, antenna reception pattern, transmit power, channel selection, selection of sub channels, and selection of sub carriers.

9. A relay as claimed in claim 5, wherein said transmitter is arranged to use different transmit power for different sub channels or sub carriers.

10. A relay as claimed in claim 5, wherein a sub channel or sub carrier is changed at relay node in response to an external signal.

11. A relay as claimed in claim 5, wherein at least one of said receiver and transmitter comprises an antenna array.

12. A relay as claimed in claim 11, wherein said control means is arranged to control said antenna, array to form beams.

13. A relay as claimed in claim 11, wherein said antenna array comprises a calibrated array.

14. A relay as claimed in claims 11, wherein an unstructured array is used.

15. A relay as claimed in claim 11, wherein said control means is arranged to calibrate said array.

16. A relay as claimed in claim 15, wherein said control means uses location information to determine communication directions for given ones of said nodes, said location information comprising location information of at least one of: said relay; and at least one of said first nodes and said second nodes.

17. A relay as claimed in claim 15, wherein said control means is arranged to use communication directions to calibrate said array.

18. A relay as claimed in Claim 15, wherein said control means is arranged to control said transmitter to transmit using predefined weights to at least one node, to process signals received by said receiver from said node and to alter said predefined weights for transmitting to said node.

19. A relay as claimed in claim 11, wherein said control means is arranged to control signals transmitted by said transmitter to have co-phasing.

20. A relay as claimed in claim 18 when appended thereto, wherein said weights comprise one of co-phasing weights and beam steering weights.

21. A relay as claimed in claim 18, wherein said receiver is arranged to receive from one of said first-nodes information about a beam direction for a given one of said second nodes.

22. A relay as claimed in claim 12, wherein said relay is arranged such that a same beam is used for one of: a single sub-carrier, a block of sub-carriers, and all sub-carriers.

23. A relay as claimed in claim 12, wherein the control means is arranged to control the receiver such that signals for only part of said coverage area are processed.

24. A relay as claimed in claim 12, wherein said control means is arranged to control the power with which said signal is transmitted by said transmitter.

25. A relay as claimed in claim 12, wherein said controlling circuit is arranged to process a probing signal received from said second nodes.

26. A relay as claimed in claim 25, wherein said control means is arranged to control the power used by said transmitter in dependence on said probing signal.

27. A relay as claimed in claim 25, wherein said control means is arranged to control resource allocation in dependence on said probing signal.

28. A relay as claimed in claim 25, wherein said probing signal comprises at least one of the following: a pilot signal; known reference information; probing signal transmit power information; resource allocation information, priority information for relaying; and channel characteristic information.

29. A relay as claimed in claim 28, wherein said controlling circuit is arranged to decode information in said probing signal.

30. A relay as claimed in claim 25, wherein said controlling circuit is arranged to measure impulse and/or frequency responses of channels based on said probing signal.

31. A relay as claimed in claim 25, wherein said relay is arranged to communicate with at least one other relay whereby said control means is arranged to make decisions on resource allocation based on information received from said at least one other relay.

32. A relay as claimed in claim 25, wherein said relay is arranged to use the following protocol:
$${t}_{k} = {τ}_{k} ( {\sum }_{l = 1}^{{N}_{s}} {γ}_{k , l} {e}^{- j ( {φ}_{h} arg ( {h}_{k , l} ) + {φ}_{f} arg ( {f}_{l , k} ) )} ) {r}_{k} ,$$
where τₖ is a power normalization factor
γ_{k,l} an amplitude weighting coefficient
φₕ and φ_{f} are phase weighting coefficients
rₖ a received signal
h_{k,l} and f_{l,k} are the short-term flat fading coefficients.

33. A relay as claimed in claim 32, wherein γ_{k,l} and/or at least one of the following τₖ φₕ φ_{f} are selected based on optimizing an objective function.

34. A relay as claimed in claim 32, wherein the objective function includes one or more of:
Minimising average bit error rate;
Maximising signal-to-interference-and-noise ratio;
Maximising network capacity; and
Minimising outage probability.

35. A relay as claimed in claim 25, wherein different weighting coefficients are used for different sub channels or sub carriers.

36. A relay as claimed in claim 25, wherein said first nodes comprise base stations.

37. A relay as claimed in claim 25, wherein said second nodes comprise user equipment.

38. A relay as claimed in claim 25, wherein said control means is arranged to modify transmission parameters.

39. A relay comprising: a receiver for receiving a signal from a first node; a transmitter for forwarding said signal to a second node; wherein at least one of said receiver and transmitter is arranged to be spatially selective such that at least one of said receiver and transmitter spatially selects only part of a coverage area of said relay.

40. A relay as claimed in claim 39, wherein said relay is arranged to control the power with which said signal is transmitted by said transmitter.

41. A network comprising a plurality of relays as claimed in claim 39, wherein the control means of at least one of the relay controls the weighting of the transmitted signal using at least channel information related to at least two of said first and second nodes, wherein the channel information is combined linearly with different relative weights for at least two different nodes.

42. A network as claimed in claim 41, wherein said two relay units are arranged to transmit substantially synchronously.

43. A network as claimed in claim 41, wherein transmission timing of said nodes is controlled by an external signal

44. A network as claimed in claim 43, wherein said external signal is received from a positioning system.

45. A network as claimed in claim 44, wherein said positioning system is a GPS system.

46. A network as claimed in claim 41, wherein radiated power for two relay units is different.

47. A network as claimed in claim 46, wherein the radiation power is controlled by an external signal

48. A network as claimed in claim 43, wherein said external signal—is generated by at least one of first or second nodes.

49. A relay method for use in a communications network, said method comprising the steps of: receiving signals from a plurality of first nodes; transmitting a transmission signal derived from said received signal to one of a plurality of second nodes by controlling a transmitter to transmit the transmission signal over only a part of said coverage area.
